(19) United States
(12) Patent Application Publication
(10) Pub. No.: US 2019/0141283 A1
(43) Pub. Date: May 9, 2019

(54) SYSTEM FOR VIDEO RECORDING

(71) Applicant: Jacob Haas, Boston, MA (US)

(72) Inventor: Jacob Haas, Boston, MA (US)

(21) Appl. No.: 15/804,715

(22) Filed: Nov. 6, 2017

(51) Int. Cl. H04N 5/91; H04N 5/232; G11B 27/031; G11B 27/10; H04N 21/4335; H04N 21/472; H04N 21/4223; H04N 21/41

(52) U.S. Cl. CPC H04N 5/91; H04N 5/23203; G11B 27/031; H04N 21/4126; H04N 21/4335; H04N 21/47205; H04N 21/4223; G11B 27/10

(57) ABSTRACT

A system and method for utilizing a camera to continuously record video, and a controller to selectively save portions of the recorded video is provided. The system includes a camera and a wireless controller. In operation, the camera records continuously. Upon receipt of a signal from the controller, the camera saves a previous amount of the video to memory. As configured the system allows a user to easily capture exciting moments as they occur without the need to be monitoring and tracking events with the camera.

### BACKGROUND OF THE INVENTION

### Field of the Invention

The present invention relates generally to video recording systems. More particularly the present invention relates to a system that can continuously record and store video clips, and that can automatically join these clips into a single video.

### Description of Related Art

With the development and mobilization of high quality photography and videography equipment, it has become very easy to take copious amounts of photos and videos. For example, when on vacation, it is very common to film a great deal of footage with the intent to share the video(s) on social media. However, once returned from vacation, people go back to their busy day to day lives, and the video content remains unedited and unconsolidated because sorting through footage and editing is time consuming and cumbersome.

Often exciting moments are unplanned, and may be over by the time the camera is taken out, activated, and set to record. Sometimes, this issue is solved by continuous or nearly continuous recording. However, when users continuously record video, it creates even more content to sift through. Further, when manipulating a camera during exiting events, often the user can miss out on the actual event experience, instead being distracted by using their cameras. Excessive recording also rapidly fills up the memory on devices, meaning that content must be processed by a user, potentially quality content must be deleted, or future recordings cannot take place.

Therefore, what is needed is a system that can automatically record content, condense this content into manageable amounts, and allow a user to not have to manage camera equipment, instead allowing them to enjoy the moment.

### SUMMARY OF THE INVENTION

The subject matter of this application may involve, in some cases, interrelated products, alternative solutions to a particular problem, and/or a plurality of different uses of a single system or article.

In one aspect, a video recording system is provided. The system includes a camera and a controller. The camera has a processor, a temporary memory, and a memory. The controller is in wireless communication with the camera. As configured, the camera is operable to continuously record a video, storing the recorded video in the temporary memory. Upon an input relating to a time of pre-recorded video from the controller, the processor of the camera is configured to cause the camera to save a portion of the recorded video from the temporary memory to the memory as a video clip the portion of the recorded video being from a most recent recorded video back to the time selected of the previously-recorded video. The processor is then configured to cause the camera to delete a remainder of the video from the temporary memory. Further, the processor is configured to cause the camera to begin recording again after receipt of the wireless signal from the controller. As discussed below, when terms are used referring to functional elements and abilities of the camera and controller, those skilled in the art will understand that the appropriate computerized components are operable to cause this functionality.

In another aspect, a method of forming a computerized video data structure is provided. The method begins with a computer continuously recording a video by a camera. The video is stored in a temporary memory of the camera. The camera may receive a wireless signal from a controller which instructs the camera to save a portion of the previously-recorded video starting at the present and saving back an amount of time equal to a selected period of time as instructed by the controller. This saving step comprises saving the video of the determined length to a memory of the camera as a video clip. Next, the camera may automatically delete a remainder of the video that was not saved from the temporary memory, and may begin recording again.

In yet another aspect, the processor is further configured to cause the camera to form a new data structure and store this data structure in the memory. The data structure formed is a single video comprising the video clip as well as a plurality of other video clips which have been saved in the same manner as the video clip noted. This data structure is configured to sequentially play all of the video clips in a single video.

### BRIEF DESCRIPTION OF THE DRAWINGS

FIG. 1 provides a schematic of an embodiment of the invention in use.

FIG. 2 provides a flow chart of steps of an embodiment of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a video recording system which allows for continuous recording by a remote camera in wireless communication with a controller. Upon activation by the controller, a predetermined amount of previously-recorded content may be saved to a memory on the camera as a video clip. For example, the system may continuously record, and upon activation by the controller, the past 30 seconds of recorded footage (which is the previously-recorded content) may be saved as a video clip. The camera has a memory on which the recorded footage is saved and optionally compiled into a single combined video with other selected clips. In many embodiments, leftover footage which is not the previously-recorded content is deleted. In operation, they system operates to limit an amount of memory used while also continuing to record video, thereby maximizing the amount of time a user can go between switching cameras or memory storage devices.

The camera of the present invention may be any computerized digital camera. The camera comprises a memory for storing video data, as well as a camera lens and related components for taking the photographs and/or video recording. The camera further comprises a processor capable of operating the camera, including receiving an input to activate recording, causing storage of the recorded video, and the like. The camera may also comprise a wireless communications module such as a transceiver or receiver for wireless communication with the controller. Further still, the camera may have a quantity of temporary memory for storing the video as it is recorded, before it is saved on the memory as a recorded video clip. This temporary memory may be the same as the memory, or may be a separate different memory. The camera has at least an input, usually in the form of a “shutter” button which takes the photograph/video. Typically the camera may also have other inputs, and potentially an output display as well.

The controller of the present invention may be any electronic device in wireless communication with, or with a direct/wired connection to the camera that is capable of sending an input to the camera via a wireless communication to trigger saving of the previously-recorded video for a predetermined time period. In many embodiments, the controller may be adjustable to provide different instructions for the predetermined time period. This adjustability may be in the form of pre-programmed buttons or actuation areas, or may be programmable into the controller through an interface. In a particular embodiment, the controller may comprise one or more pre-programmed buttons to record a predetermined time period. In a further embodiment, this controller may be embedded or connected to a clothing item.

The system of the present invention may be carried out using any number of different device embodiments. Such embodiments include, but are not limited to: a camera/storage device having a set of programming instructions loaded into it to operate as the camera of the present invention; a set of programming instructions on a second remote device such as a smart phone which can control an existing camera to operate as the camera of the present invention; and/or a new, standalone and dedicated system which uses a camera and controller specifically designed to operate as discussed with regard to the present invention; or a combination of any of these embodiments.

In a particular embodiment, the controller may be a computerized mobile device such as a smartphone. In such an embodiment, a set of programming instructions stored in the memory and actionable by the smartphone processor allows the device to be used to receive inputs through a user interface (typically a touch screen, but any interface will suffice) to input specific times of previously-recorded video to save. The smartphone controller may also actuate the saving of the video by sending the wireless output for the camera input, and the like. Further, in computerized mobile device embodiments such as this, the device may be programmed to display, on a display of the device, a preview of the saved video either before or after it is saved. In similar embodiments, photographs, audio, and/or video of the saved video clip, or to-be-saved video clip may be presented on the display after or before saving of the video clip. In another embodiment, after selection of the predetermined time of previously-recorded video for the camera to save, the display of the computerized controller may be configured to automatically play all or a portion of the video. This displayed video clip may then be confirmed to save, which may then instruct the camera to save the video clip and delete a remainder of portion of unsaved video data that was recorded before the saved video clip.

In use, the present invention may operate as follows. A computerized digital camera may be set to record video in a continuous fashion. In a particular embodiment, the camera may be configured to record video until the temporary memory of the camera is full (or some other predetermined recording time period, such as 30 minutes, one hour, two hours, and the like), and then configured to delete (or cease to save) older video as newer video is recorded. This may allow for long term continuous operation.

Upon the camera viewing an interesting event, a user may instruct the camera to save a quantity of the previously-recorded video by input into a controller. For example, if a brief event occurs, the user could save a five, ten, or fifteen second video clip from the present back to the selected time period. If a longer event occurs, the user may provide an input to the controller to save the last one, five, ten, fifteen minutes, for example. The controller then communicates with the camera, causing the camera to save a video clip of the selected time. It should be understood that any time period may be selected by the controller and saved by the camera without straying from the scope of this invention. The video of the specified length (from present back to the selected time period) is then saved by the camera as the video clip. In one embodiment, the camera may be configured to continue to record video during the saving of the clip, allowing it to continue to record potentially interesting video during the saving process without or with only negligible (0-5 seconds) interruption.

In one further embodiment, after the video clip has been saved, a remainder of recorded video (as in, any video recorded before the selected clip) may be deleted. The video recording by the camera may then automatically restart until the controller provides a save command.

In still a further embodiment, the camera may be configured to automatically add the saved video clip to the end of a longer video data structure which is comprised of a plurality of other saved video clips. In this embodiment, the camera appends the newly saved video clip to an end of the existing video comprised of the compilation of video clips which have been previously saved as video clips in the same manner as above. In a starting condition with no previously saved clips, the data structure may be formed having just a first newly saved video clip, and as new clips are saved, they are appended sequentially. In a further optional embodiment, the newly combined video clip may be saved to the camera memory, and the older compilation video and saved video clip may be deleted so that only the newest composition video is saved in the memory, as opposed to a plurality of clips and/or a plurality of composition videos. Further still, a data structure of the combined video clip may allow a user, through the computerized controller, to separate out the various video clips making up the combined video clip. Further still, the camera may be configured to automatically input transitions into the combined video clip between the individual clips. In an alternative embodiment, a user may be allowed to select, through the user interface of the controller, a particular one of a plurality of different pre-programmed transitions to be inserted by the computerized camera between two video clips in the combined video clip.

The above noted embodiment utilizes a camera that is programmed to automatically form a data structure comprised of a plurality of video clips configured to play sequentially or with transitions between each clip. This data structure may be formatted in any number of known or newly developed video data formats, and may be transferred via wireless (or wired) connection from the camera to a device capable of displaying the video. Further, an external computerized device, such as the controller in some embodiments, or a different computer, may be capable of additional editing of the compilation video data structure. The data structure may further include markers to identify start and end points of the different clips, simplifying editing by allowing the computerized device to identify and isolate the different video clips. These markers may be automatically inserted by the computerized camera when creating the compilation video. Editing by the computerized device may include, but is not limited to, removing video clips, adding commentary, adding transitions between clips, adding additional video clips, adding still photographs, and the like.

Some embodiments of the present invention may be practiced on a computer system that includes, in general, one or a plurality of processors for processing information and instructions, RAM, for storing information and instructions, ROM, for storing static information and instructions, a data storage unit such as a magnetic or optical disk and disk drive for storing information and instructions, modules as software units executing on a processor, an optional user output device such as a display screen device (e.g., a monitor) for display screening information to the computer user, and an optional user input device. The camera noted herein may include some or all of these computerized elements as well, as noted above.

As will be appreciated by those skilled in the art, the present examples may be embodied, at least in part, a computer program product embodied in any tangible medium of expression having computer-usable program code stored therein. For example, some embodiments described below with reference to flowchart illustrations of methods, apparatus (systems) and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart.

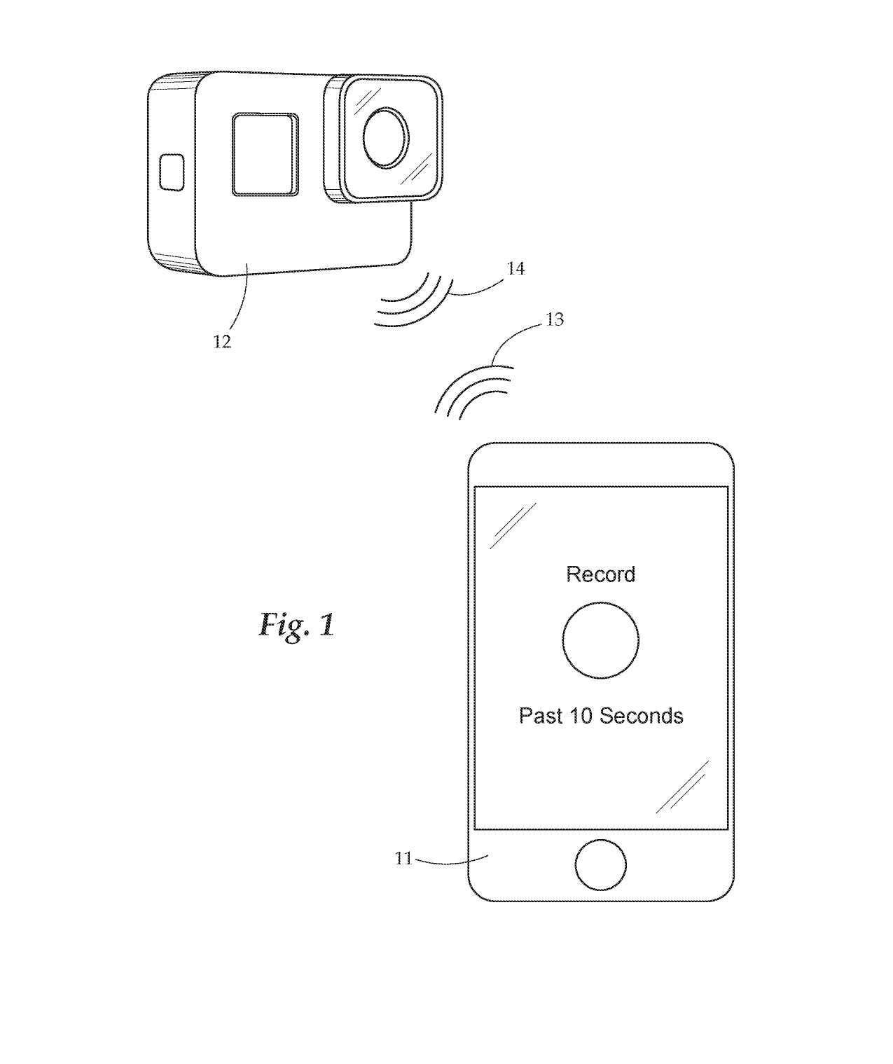

Turning now to FIG. 1, an embodiment of the present invention is provided. In this view, camera 12 is configured to be continuously recording as discussed above. A controller 11, shown in this embodiment as a smart phone having a touch screen display, is configured to instruct the camera to save a previously-recorded video clips for the past selected period of time. In the embodiment shown, a user can select a time period for the video to be recorded through the touch screen interface. Further, upon receipt of a touch input of a screen area corresponding to an actuation button, the controller 11 is configured to send a signal 13 to the camera 12 instructing the camera to record and save the previously-recorded video for the selected past time period (in this embodiment, the past 10 seconds) to the camera's 12 memory (not shown). The camera 12 can also send a signal 14 to the controller 11, such as a signal confirming saving of the video, a sample of the video, the video itself, and any other information.

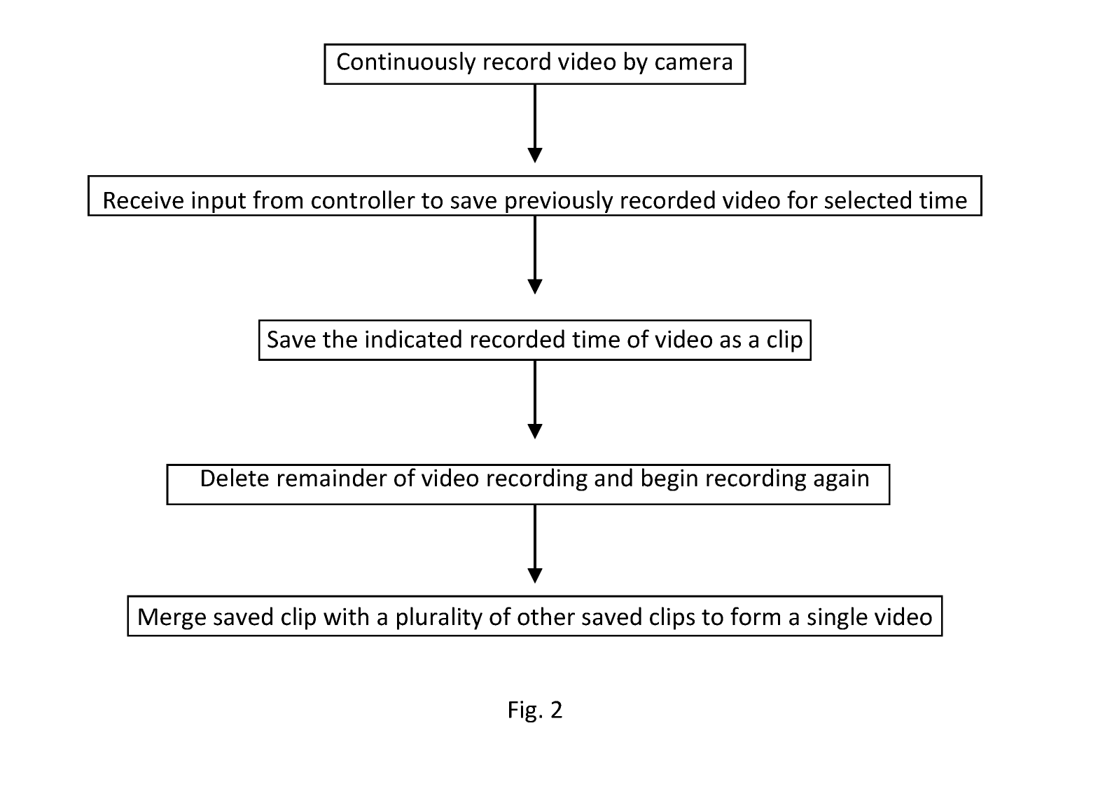

FIG. 2 shows a flow chart of one embodiment of the present invention. In this embodiment, the camera is set to continuously record video. Upon receipt of a signal from a controller, the camera is programmed to automatically save a portion of previously recorded video of a time period indicated by the controller as a video clips formatted as a video data file. The camera then deletes a remainder of the recorded video, and begins recording again. The step of beginning to record again may, in some embodiments, begin as soon as the saving step begins, allowing for continuous recording. In other embodiments, a small gap in the video recording may exist. In this embodiment, after the video recording by the camera has started again, the camera is also configured to merge the saved video clip with a larger video file data structure comprised of a plurality of clips, to form a single compilation video of a plurality of clips, including the recently saved clip. As noted, in other embodiments, there may be a small delay of recording during the merging step though some embodiments may utilized continuous recording.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A video recording system comprising:
a camera, the camera having a processor, a temporary memory, and a memory;
a controller, the controller in wireless communication with the camera;
wherein the camera is configured to continuously record a video, storing the recorded video in the temporary memory;
wherein the controller is configured to receive an input relating to a time of pre-recorded video, and configured to provide a wireless output signal to the camera indicating the time of pre-recorded video to save;
wherein the processor is configured, upon receipt of the wireless output signal, to cause the camera to save a portion of the recorded video from the temporary memory to the memory as a video clip, the portion of the recorded video being from a most recent recorded video back to the time selected of the previously-recorded video, the processor further configured to cause the camera to delete a remainder of the video of the temporary memory, and configured to cause the camera to begin recording again after receipt of the wireless output signal of the controller.

2. The system of claim 1 wherein the temporary memory is a portion of the memory.

3. The system of claim 1 wherein the processor is further configured to cause the camera to form a new data structure stored in the memory, the data structure formed as a single video comprising the video clip and a plurality of other video clips configured to play sequentially in a single video.

4. The system of claim 3 wherein the data structure comprises a video transition between each of the video clip and plurality of other video clips.

5. The system of claim 3 wherein the data structure comprises a plurality of computer-readable markers, each marker corresponding to one of the video clip and the plurality of other video clips, the plurality of markers allowing a computer to identify each of the video clips individually.

6. The system of claim 3 wherein the processor is configured to cause the video clip and plurality of other video clips to be deleted from the memory after or during the creation of the new data structure.

7. The system of claim 1 wherein the controller is a smart phone.

8. The system of claim 7 wherein the smart phone comprises a touch screen display, the touch screen display operable to receive an input to program the time of previously-recorded video to record.

9. The system of claim 7 wherein the processor causes the camera to send a wireless signal to the smart phone containing at least a portion of the video clip, the smart phone operable to display the at least the portion of the video clip on the touch screen display.

10. The system of claim 1 wherein the time of the previously-recorded video to save is one of ten seconds, thirty seconds, forty five seconds, one minute, five minutes, and ten minutes.

11. The system of claim 1 wherein the processor causes the camera to immediately start recording again after the wireless output signal is received and at the same time as the camera is saving the video clip to the memory.

12. A method of forming a computerized video data structure comprising the steps of:
recording a video continuously by a camera, the video being stored to a temporary memory of the camera;
receiving a wireless signal by the camera from a controller, the wireless signal instructing the camera to save a portion of the previously-recorded video from a present time back for a selected period of time as instructed by the controller, the saving comprising saving the previously-recorded video for the period of time to a memory of the camera as a video clip;
deleting, automatically by the camera, the remainder of the video of the temporary memory; and
recording a second video by the camera after receipt of the wireless signal from the controller.

13. The method of claim 12 wherein the temporary memory is a portion of the memory.

14. The method of claim 12 further comprising the step of forming a new data structure stored in the memory by the camera, the data structure formed as a single video comprising the video clip and a plurality of other video clips saved in the memory, the data structure configured to play as a single video.

15. The method of claim 14 wherein the step of forming the data structure comprises adding a video transition between each of the video clip and plurality of other video clips by the camera.

16. The method of claim 14 wherein the step of forming the data structure comprises adding a plurality of computer-readable markers into the data structure, each marker corresponding to one of the video clip and the plurality of other video clips, the plurality of markers allowing identification of each of the video clips individually.

17. The method of claim 14 further comprising the step of deleting, by the camera, the video clip and the plurality of other video clips from the memory after or during the step of creating the new data structure.

18. The method of claim 12 wherein the controller is a smart phone.

19. The method of claim 18 wherein the smart phone comprises a touch screen display, and comprising the step of selecting the time length using the touch screen display.

20. The method of claim 12 wherein the step of recording the second video is begun immediately after the wireless signal from the controller is received.
